(19) United States
(12) Patent Application Publication
(10) Pub. No.: US 2008/0083298 A1
(43) Pub. Date: Apr. 10, 2008

(54) Counter weight flywheel

(76) Inventor: Chu-Fu Lin, Yongkang City (TW)

Correspondence Address: Chu-Fu LIN, P.O. BOX 90,, Tainan City 70499, omitted

(21) Appl. No.: 11/544,571

(22) Filed: Oct. 10, 2006

(51) Int. Cl. F16C 15/00

(52) U.S. Cl. 74/572.2

(57) ABSTRACT

A counter weight flywheel includes an inner cylindrical body and an outer cylindrical body disposed between an upper faceplate and a lower faceplate. A shaft tube is positioned in the inner cylindrical body, and plural tensile bars are inserted in the inner cylindrical body, respectively having one end secured on the fixing members of the shaft tube and the other end fixed on the inner wall of the outer cylindrical body. Plural reinforcing bars and plural reserve tubes are respectively fixed between the inner and the outer cylindrical body. A counter weight area formed between the inner and the outer cylindrical body is filled up with concrete or iron sand, and the inner cylindrical body has its interior forming a hollow area. Thus, the counter weight flywheel is made by combining iron plates and concrete or iron sand.

### BACKGROUND OF THE INVENTION

1. Field of the Invention

This invention relates to a counter weight flywheel, particularly to one made by combining iron plates and concrete or iron sand together, able to greatly lower cost for material and processing and elevate economic gain.

2. Description of the Prior Art

For the present, circular flywheel counter weight systems used for industrial machinery are mostly made of cast iron by injection molding. However, the price of metal continues to rise nowadays so the cost of metallic material needed for making a large-sized counter weight flywheel is extremely high. In addition, during operating, the counter weight flywheels always rotate at high speed; therefore, to make a counter weight flywheel, both the ratio of the entire weight and the circumferential value must attain to zero error so as to prevent the flywheel from swaying during operating and enable the flywheel to work normally. Further, each counter weight flywheel, after injection molded, must be ground smooth and make round by a processing master machine, thus taking a lot of time and exertion and costing much in processing. Furthermore, it is difficult to find a large-sized processing master machine for carrying out processing of a large-sized counter weight flywheel.

### SUMMARY OF THE INVENTION

The objective of the invention is to offer a counter weight flywheel, able to lower cost in material as well as in processing and greatly elevate economic gain.

A first feature of a counter weight flywheel in the present invention includes an upper faceplate and a lower faceplate respectively bored with a shaft hole in the center. The upper faceplate is bored with a plurality of through holes and insert holes respectively spaced apart equidistantly, and each through hole is fitted therein with a cover member. An outer cylindrical body and an inner cylindrical body, which is fitted in the interior of the outer cylindrical body, are disposed between the upper and the lower faceplate. The inner cylindrical body has its outer wall equidistantly bored with a plurality of insert holes. A plurality of tensile bars is respectively inserted through the insert holes of the inner cylindrical body. A shaft tube is positioned in the center of the inner cylindrical body, having its outer wall secured with a plurality of fixing members for fixing the tensile bars. A plurality of reinforcing bars are annularly fixed between the outer and the inner cylindrical body, and a plurality of reserve tubes are equidistantly set between the outer and the inner cylindrical body, respectively having one end inserted in the insert holes of the upper faceplate. Concrete is grouted into the space between the inner and the outer cylindrical body to form a counter weight area, and the inner cylindrical body has its interior forming a hollow area.

A second feature of a counter weight flywheel in the present invention includes an upper faceplate and a lower faceplate respectively bored with a central shaft hole. The upper faceplate is equidistantly bored with plural through holes and plural insert holes, and the through holes are respectively fitted therein with a cover member. An outer cylindrical body and an inner cylindrical body, which is positioned in the interior of the outer cylindrical body, are assembled between the upper and the lower faceplate. The inner cylindrical body has its outer wall equidistantly bored with plural insert holes. Plural tensile bars are respectively inserted through the insert holes of the inner cylindrical body. A shaft tube is positioned in the center of the inner cylindrical body, having its outer wall firmly mounted with a plurality of fixing members for fixing the tensile bars. Plural reinforcing bars are annularly positioned between the outer and the inner cylindrical body, and plural reserve tubes are equidistantly set between the outer and the inner cylindrical body, respectively having one end inserted in the insert holes of the upper faceplate. Iron sand is injected into the space between the inner and the outer cylindrical body to form a counter weight area, and the inner cylindrical body has its interior forming a hollow area.

### BRIEF DESCRIPTION OF DRAWINGS

This invention will be better understood by referring to the accompanying drawings, wherein:

FIG. 1 is an exploded perspective view of a counter weight flywheel in the present invention;

FIG. 2 is a cross-sectional view of the counter weight flywheel in the present invention;

FIG. 3 is an upper view of the counter weight flywheel in the present invention; and

FIG. 4 is a perspective view of the counter weight flywheel in the present invention.

### DETAILED DESCRIPTION OF THE PREFERRED EMBODIMENT

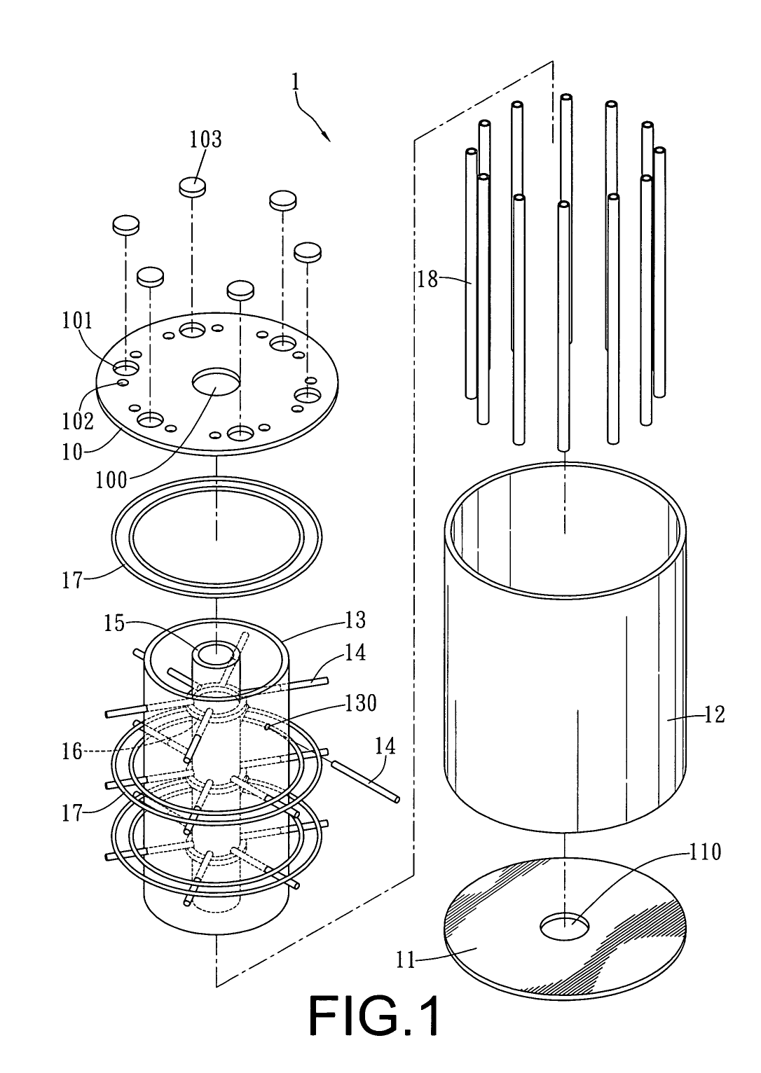

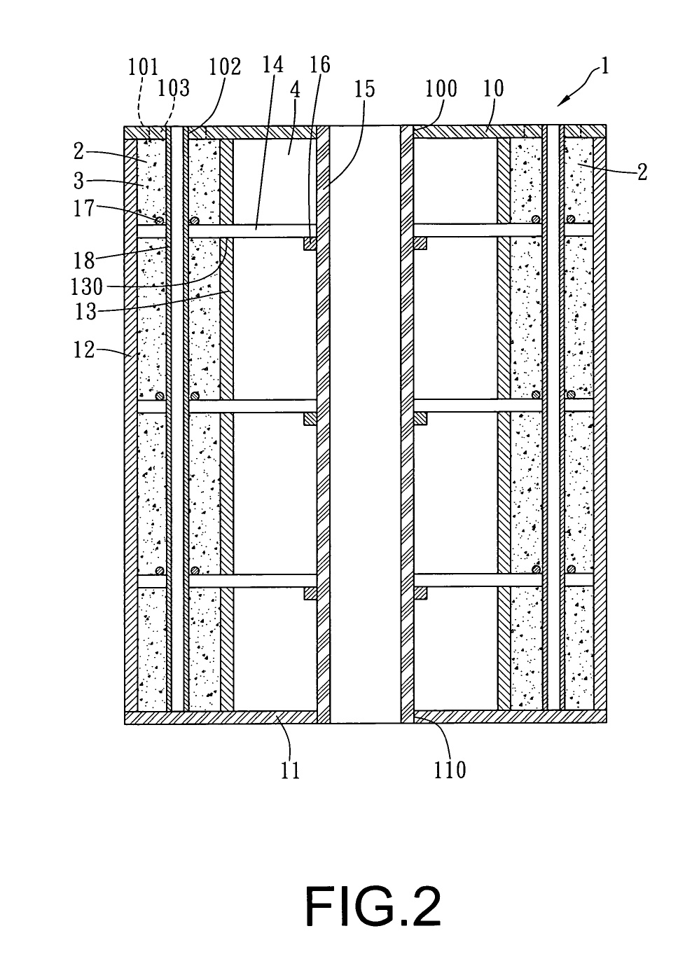

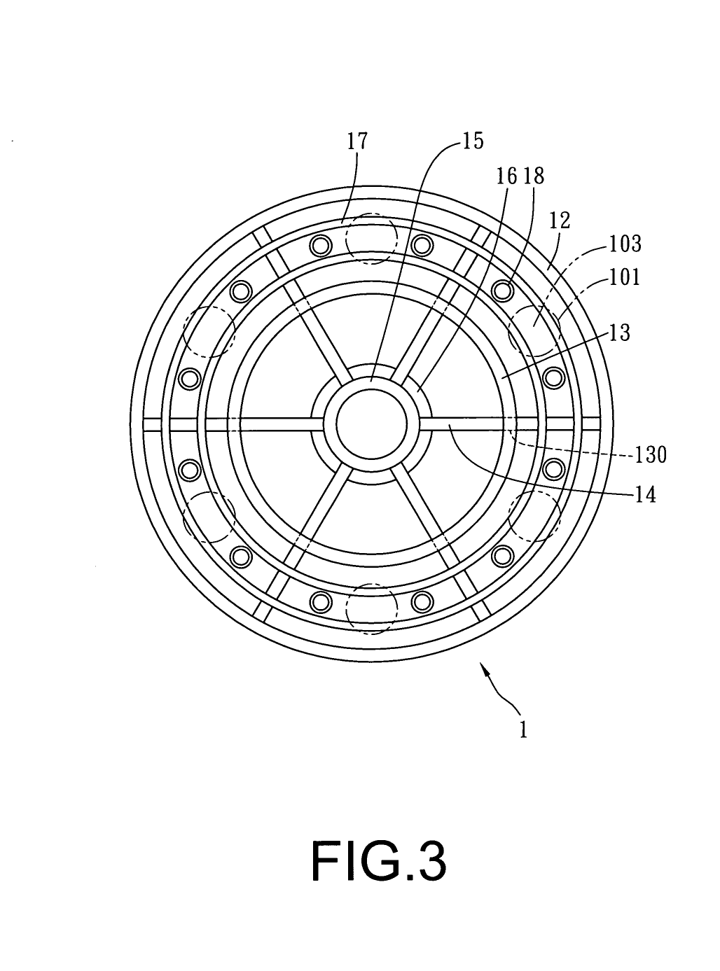

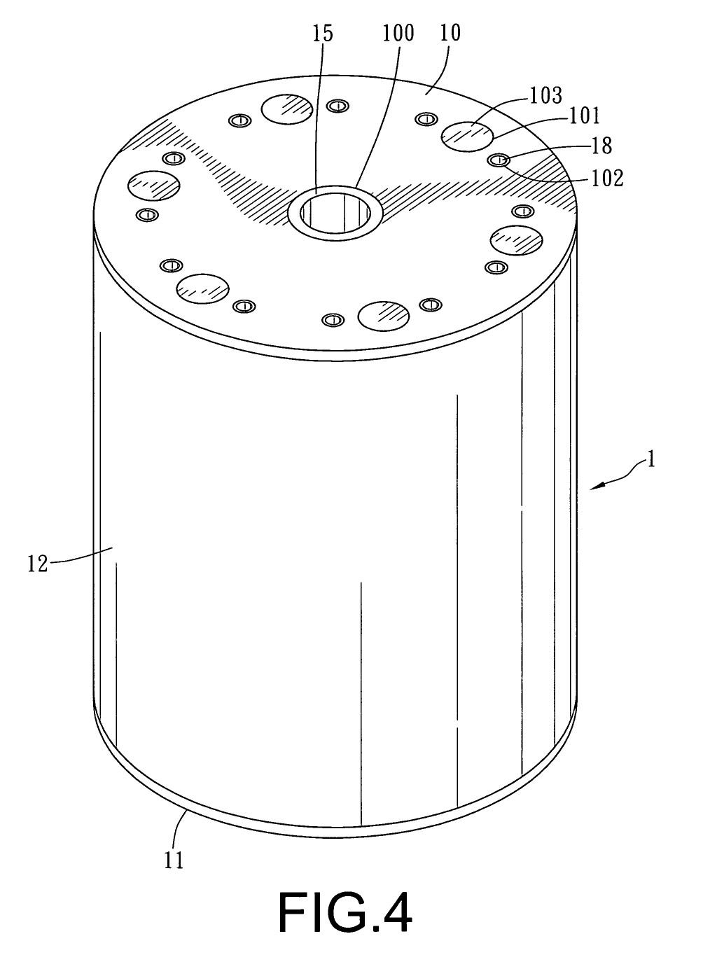

A preferred embodiment of a counter weight flywheel made of one-twelfth of iron and eleven-twelfths of concrete in the present invention, as shown in FIGS. 1-4, includes an upper faceplate 10, a lower faceplate 11, an outer cylindrical body 12, an inner cylindrical body 13, a plurality of tensile bars 14, a shaft tube 15, a plurality of reinforcing bars 17 and a plurality of reserve tube 18 combined together.

The upper and the lower faceplate 10, 11 are respectively made of iron plate with a proper thickness, cut into a circular plate according to the circumferential size of the counter weight flywheel 1. The upper and the lower faceplate 10, 11 are respectively bored with a shaft hole 100, 110 in the center. The upper faceplate 10 is bored with 3-6 through holes 101 and 6-12 insert holes 102 respectively spaced apart equidistantly, and each through hole 101 filled therein with a cover member 103.

The outer and the inner cylindrical body 12, 13 are respectively made of iron plates, and the inner cylindrical body 13 having its outer wall equidistantly bored with a plurality of insert holes 130 is fitted in the interior of the outer cylindrical body 12. The outer and the inner cylindrical body 12, 13 are disposed between the upper and the lower faceplate 10, 11.

The tensile bars 14 are respectively inserted in the insert holes 130 in the outer wall of the inner cylindrical body 13.

The shaft tube 15 is an iron tube vertically fixed in the center of the inner cylindrical body 13 to serve as a bearing center of the counter weight flywheel 1. The length of the shaft tube 15 is tantamount to the thickness of the counter weight flywheel 1, and the shaft tube 15 has its outer wall mounted with a plurality of fixing members 16 respectively for fixing one end of the tensile bar 14.

The reinforcing bars 17 annularly positioned between the outer and the inner cylindrical body 12, 13 are made into a net-like structure formed by different-sized steel bars connected in series.

The reserve tubes 18 made of iron tubes are equidistantly disposed between the outer and the inner cylindrical body 12, 13 and respectively have one end inserted in the insert holes 102 of the upper faceplate 10.

To make a counter weight flywheel, as shown in FIGS. 1-4, firstly, the shaft tube 15 is vertically positioned in the center of the inner cylindrical body 13, and the tensile bars 14 are respectively and equidistantly inserted through the insert holes 130 of the inner cylindrical body 13 and have their inner ends respectively welded on the shaft tube 15 and on the fixing members 10 of the shaft tube 15. Then the tensile bars 14 have the portions that are inserted in the insert holes 130 of the inner cylindrical body 13 firmly welded and fixed in position. Next, the reinforcing bars 17 are respectively welded and fixed on the tensile bars 14, letting the reinforcing bars 17 connected in series to form a net-like structure. Subsequently, the inner cylindrical body 13 has its lower end welded on the lower faceplate 11 and the shaft tube 15 has its lower end inserted in the shaft hole 110 of the lower faceplate 11 and welded together with the lower faceplate 11. Then, the reserve tubes 18 have their lower ends respectively and equidistantly welded on the lower faceplate 11, and the outer cylindrical body 12 is fitted around the inner cylindrical body 13, having its lower end welded on the lower faceplate 11, and then the tensile bars 14 have their outer ends respectively welded on the inner wall of the outer cylindrical body 12, letting the reserve tubes 18 equidistantly positioned between the inner and the outer cylindrical body 13, 12. Afterward, the upper faceplate 10 is welded on the upper ends of the outer and the inner cylindrical body 12, 3, letting the upper end of the shaft tube 15 inserted in the shaft hole 100 of the upper faceplate 10 and welded with the upper faceplate 10. Then, the reserve tubes 18 have their upper ends respectively inserted in the insert holes 102 of the upper faceplate 10 and welded with the upper faceplate 10. Lastly concrete 2 is grouted into the space between the inner and the outer cylindrical body 13, 12 through the through holes 101 of the upper faceplate 10, letting the concrete fill up the space between the inner and the outer cylindrical body 13, 12 to form a counter weight area 3 in which the concrete 2, the tensile bars 14 and the reinforcing bars 17 are combined together. After the concrete 2 is solidified, the cover members 103 are respectively filled in the through holes 101 of the upper faceplate 10 and welded together with the upper faceplate 10. Thus, the counter weight area 3 is formed between the inner and the outer cylindrical body 13, 12 and the counter weight area 3 (also being a centrifugal point) is usually located at a portion of one-fifth distant from the outer end of the diameter of the whole counter weight flywheel 1, and the inner cylindrical body 13 has its interior forming a hollow area 4. Thus, the net-like reinforcing bars 17 fixed in the counter weight area 3 are able to greatly increase the strength of the concrete 2 of the counter weight area 3, and such a design is based on the same principle as that of a reinforced concrete structure.

After finished, the counter weight flywheel 1 of this invention has to be tested in the specific gravity value. The specific gravity value of the whole counter weight flywheel 1 can be adjusted by means of the reserve tubes 18 positioned in the counter weight area 3. When it is detected that certain portion of the counter weight flywheel 1 has to be added with weight, the reserve tubes 18 of this portion of the counter weight flywheel 1 can be fill therein with iron materials of equivalent specific gravity to let the specific gravity value of a respective portion of the counter weight flywheel 1 attain to zero error. In addition, the whole external appearance of the counter weight flywheel 1 looks even and smooth, as the flywheel 1 is made of iron plates welded together; therefore, what should be done is to have the welded portion of the iron plates ground and polished to make the surface of the whole counter weight flywheel 1 extremely even and smooth, needless to be flattened by a processing master machine and thus saving time and cost in processing.

Substantially, the cost of a conventional counter weight flywheel made of cast iron is pretty high. For the present, one ton of cast iron is about NT$40,000 and the processing expense of a processing master machine is about NT$10,000, so the total expense for making the conventional counter weight flywheel is NT$50,000 or so. Supposed that the conventional counter weight flywheel weighs 10 tons, the expense needed for such a counter weight flywheel will be up to NT$50,000. Compared with the conventional counter weight flywheel, the counter weight flywheel of this invention costs much less. The counter weight flywheel of this invention is made of 1/12 of iron and 11/12 of concrete, and if the counter weight flywheel weighs 10 tons, the iron is 0.83 tons and the concrete is 9.17 tons. The expense of one ton of iron is NT$20,000 so the total expense of 0.83 tons of iron is NT$16,600, and the expense of 2,000 pounds of concrete is NT$1,700 so the total expense of 9.17 tons of concrete is NT$6,510. Therefore, the total expense of the iron and the concrete of the counter weight flywheel of this invention is NT$23,110, and it is needless to pay for the processing of a processing master machine. Evidently, the cost of making the counter weight flywheel of this invention (about NT$23,110) is 16 times lower than the cost of making the conventional counter weight flywheel (about NT$500,000), greatly reducing producing cost and elevating economic gain.

Further, since the counter weight flywheel of this invention does not need a processing master machine; therefore, a counter weight flywheel with a very large volume can be produced. Furthermore, the counter weight flywheel 1 of this invention can be composed of several separated sections that can be assembled together to make up a large-sized counter weight flywheel 1, which can then be disassembled for facilitating transport and assembly, able to save transporting space and cost. Moreover, the whole thickness of the counter weight flywheel of this invention, made of iron and concrete, is three times larger than that of cast iron, but the increased thickness of the counter weight flywheel will not influence the operation of a machine.

In addition, the counter weight area 3 of the counter weight flywheel 1 of this invention can be injected therein with iron sand whose specific gravity is larger than that of concrete so as to increase the weight of the counter weight area 3 and reduce the thickness of the counter weight flywheel 1, equally having the same function as that described previously.

While the preferred embodiment of the invention has been described above, it will be recognized and understood that various modifications may be made therein and the appended claims are intended to cover all such modifications that may fall within the spirit and scope of the invention.

What is claimed is:

1. A counter weight flywheel comprising:
an upper faceplate and a lower faceplate respectively bored with a shaft hole in the center, said upper faceplate bored with a plurality of through holes spaced apart equidistantly, said upper faceplate further equidistantly bored with a plurality of insert holes, each said through hole of said upper faceplate covered with a cap member;
an outer cylindrical body and an inner cylindrical body positioned in the interior of said outer cylindrical body, said inner cylindrical body and said outer cylindrical body disposed between said upper faceplate and said lower faceplate, said inner cylindrical body having its outer wall equidistantly bored with a plurality of insert holes;
a plurality of tensile bars respectively inserted through said insert holes of said inner cylindrical body;
a shaft tube vertically fixed in the center of said inner cylindrical body, said shaft tube having its outer wall secured with a plurality of fixing members respectively for fixing one end of said tensile bars;
a plurality of reinforcing bars annularly positioned between said outer cylindrical body and said inner cylindrical body;
a plurality of reserve tubes equidistantly set between said outer cylindrical body and said inner cylindrical body, said reserve tubes respectively having one end inserted in each said insert hole of said upper faceplate; and
concrete grouted in the space between said inner cylindrical body and said outer cylindrical body to form a counter weight area, said inner cylindrical body having its interior forming a hollow area.

2. The counter weight flywheel as claimed in claim 1, wherein the length of said shaft tube is tantamount to the thickness of said counter weight flywheel.

3. The counter weight flywheel as claimed in claim 1, wherein said reserve tubes are filled therein with iron material for adjusting the specific gravity value of each portion of said counter weight flywheel.

4. The counter weight flywheel as claimed in claim 1, wherein said reinforcing bars disposed in said counter weight area are connected in series to form a net-like structure for increasing the strength of said concrete in said counter weight area.

5. A counter weight flywheel comprising:
an upper faceplate and a lower faceplate respectively bored with a shaft hole in the center, said upper faceplate bored with a plurality of through holes spaced apart equidistantly, said upper faceplate further equidistantly bored with a plurality of insert holes, said through holes respectively covered with a cap member;
an outer cylindrical body and an inner cylindrical body positioned in the interior of said outer cylindrical body, said inner cylindrical body and said outer cylindrical body assembled between said upper faceplate and said lower faceplate, said inner cylindrical body having its outer wall equidistantly bored with a plurality of insert holes;
a plurality of tensile bars respectively inserted through said insert holes of said inner cylindrical body;
a shaft tube vertically fixed in the center of said inner cylindrical body, said shaft tube having its outer wall secured with a plurality of fixing members respectively for fixing one end of said tensile bars;
a plurality of reinforcing bars annularly fixed between said outer cylindrical body and said inner cylindrical body;
a plurality of reserve tubes equidistantly set between said outer cylindrical body and said inner cylindrical body, said reserve tubes respectively having one end inserted in said insert holes of said upper faceplate; and
iron sand injected into the space between said inner cylindrical body and said outer cylindrical body to form a counter weight area, said inner cylindrical body having its interior forming a hollow area.

6. The counter weight flywheel as claimed in claim 5, wherein the length of said shaft tube is the thickness of said counter weight flywheel.

7. The counter weight flywheel as claimed in claim 5, wherein said reserve tubes are filled therein with iron material for adjusting the specific gravity value of respective portion of said counter weight flywheel.
